(19) United States
(12) Patent Application Publication
(10) Pub. No.: US 2014/0033006 A1
(43) Pub. Date: Jan. 30, 2014

(54) SYSTEM AND METHOD FOR SELECTION PREVIEW

(71) Applicants: Michael Easter, Bellevue, WA (US); Yeming Liu, Bellevue, WA (US); Susan Cheng, Seattle, WA (US); Amanda M. McCoy Bast, Seattle, WA (US)

(72) Inventors: Michael Easter, Bellevue, WA (US); Yeming Liu, Bellevue, WA (US); Susan Cheng, Seattle, WA (US); Amanda M. McCoy Bast, Seattle, WA (US)

(73) Assignee: Adobe Systems Incorporated, San Jose, CA (US)

(21) Appl. No.: 12/707,816

(22) Filed: Feb. 18, 2010

(51) Int. Cl. G06F 3/048; G06F 17/00

(52) U.S. Cl. 715/205; 715/823; 715/803

(57) ABSTRACT

Systems and methods to preview only selected items from a document are provided. In example embodiments, a selection of one or more selected items from within a document is received. One or more selected items may have an interactive function (e.g., animation, hyperlink, video display, trigger) applied to or associated with it. The selected one or more items are then displayed within a preview display performing the interactive function, whereby no non-selected items from the document are displayed in the preview display. Preview may also allow preview of the selected items without any interactive function being performed.

### FIELD

The present disclosure relates generally to graphics, and in a specific example embodiment, to providing a preview of selected items.

### BACKGROUND

When a user creates a document containing interactive items, such as an animated item or object, the user may need to preview the entire document even though the user is only interested in one or a few of the items on the document. For example, if a document contains three items with serial animation and the user makes a change to the third animated item, the user must preview the document from start to finish in order to view the changes to the third animated item. In other words, the user must view the animations applied to the first and second animated item even though the user is only interested in the third animated item. Therefore, the user is subjected to extra visual noise that distracts the user from what the user is ultimately interested in viewing.

### BRIEF DESCRIPTION OF DRAWINGS

Various ones of the appended drawings merely illustrate example embodiments of the present invention and cannot be considered as limiting its scope.

FIG. 1 is a block diagram illustrating an example of an environment in which example embodiments may be deployed.

FIG. 2 is a block diagram illustrating an example embodiment of a graphics engine.

FIG. 3a illustrates an example document displayed in a document display.

FIG. 3b illustrates the display of the example document of FIG. 3a with a preview display illustrating a dynamic item.

FIG. 3c illustrates the display of the example document of FIG. 3a with a preview display illustrating a static and dynamic item.

FIG. 3d illustrates an example of an alternative preview display.

FIG. 4 illustrates the example display of the example document of FIG. 3a with a preview display displaying a video.

FIG. 5 illustrates the example display of the example document of FIG. 3a and a hyperlink test display.

FIG. 6 is a flowchart of a method for creating a document and previewing items in the document.

FIG. 7 is a flowchart of a method for providing the preview of selected items.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail. As used herein, the term “or” may be construed in either an inclusive or exclusive sense.

Systems and methods to preview selected items from a document are provided. In example embodiments, a selection of one or more items from within a document is received. At least one of the one or more items has an interactive function (e.g., animation, hyperlink, video display, trigger for an action to be performed) applied to it. The selected one or more items are then displayed within a preview display having or performing the associated interactive function or in a static state. No non-selected items from the document are displayed in the preview display. Thus, example embodiments allow the user to select items and have those selected items behave in the same manner as if the user is previewing the entire document. This allows excess visual noise to be removed, reduces processing requirements, and makes the document creation process more efficient.

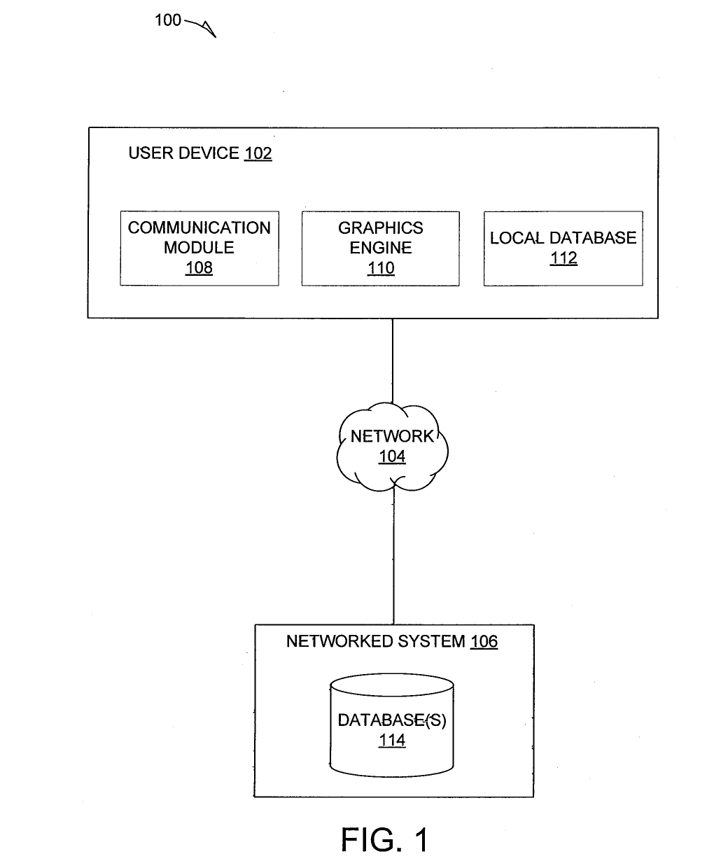

With reference to FIG. 1, an embodiment of an environment 100 in which example embodiments of the present invention may be deployed is shown. A user device 102 may be communicatively coupled via a network 104 to a networked system 106. The network 104 may comprise any one or more of a local or wide area network (e.g., the Internet).

The user device 102 is a processor-driven device (e.g., personal computer) which allows a user of the user device 102 to create documents. The user device 102 may comprise a communication module 108, a graphics engine 110, and a local database 112. The user device 102 may comprise other components (not shown) not necessary for implementation of example embodiments described herein.

The communication module 108 manages communications between the user device 102 and other components in the environment 100 and receives instructions from the user. For example, the communication module 108 may receive instructions from the user to create a document, insert or incorporate an item, and apply an interactive function to the inserted item.

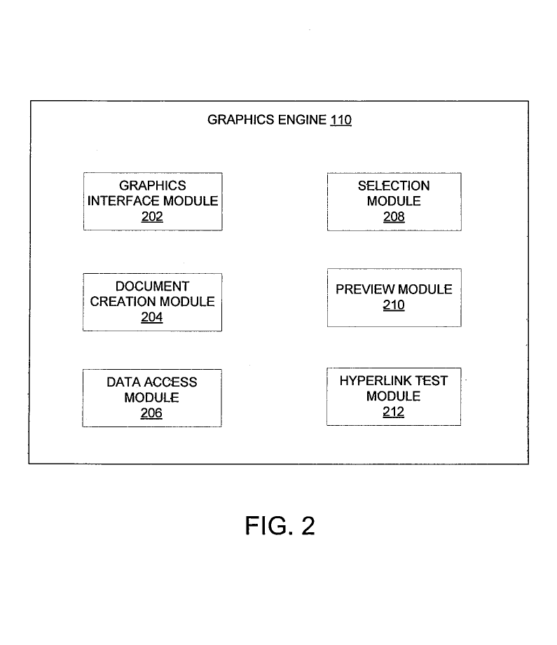

The graphics engine 110 generates documents and provides previews of selected items from the documents. The graphics engine 110 will be discussed in more detail in connection with FIG. 2.

The local database 112 stores information at the user device 102 that may be used to create and display the document. The information may include items that may be incorporated into the document. For example, the information may comprise clipart, video content, and document templates.

In example embodiments, the networked system 106 also includes one or more databases 114 and associated storage devices. The database(s) 114 may store information and items that the user may elect to import or otherwise access and use within the document the user is creating at the user device 102. For example, the databases 112 may include clipart, videos, and document templates.

While the environment 100 illustrates the user device 102 communicatively coupled to the networked system 106 in order to access data at the database(s) 108, alternative embodiments may provide a stand-alone system at the user device 102. In these embodiments, the user device 102 need not be coupled to the networked system 106 to access information for use in the document. Instead, information relevant for creating the document is self contained at the user device 102.

FIG. 2 is a block diagram illustrating an example embodiment of the graphics engine 110. The graphics engine 110 may comprise a graphics interface module 202, a document creation module 204, a data access module 206, a selection module 208, a preview module 210, and a hyperlink test module 212. The graphics engine 110 may comprise other components (not shown) not necessary for implementation of example embodiments described herein.

The graphics interface module 202 manages displays on the user device 102. The graphics interface module 202 provides a document display as well as previews of the selected items within a document in the document display. The document display may comprise creation tools for creating and manipulating items in the document. The document display may further include a preview selection to trigger a preview mode for selected items from the document.

In some embodiments, the graphics interface module 202 provides a preview panel distinct from a document display displaying the document when the preview mode is triggered. The preview panel comprises a preview display where selected items may be displayed in the preview mode. In these embodiments, the preview panel does not disable the document display. That is, the user may still perform actions on the document display while the preview panel is also being displayed. This may occur, for example, when a user has the document display on one monitor and the preview panel on a second monitor and is performing actions back-and-forth between the document display and the preview panel.

In other embodiments, a separate preview panel is not utilized. Instead, the document display will be transformed into the preview display. In these embodiments, preview may be embedded within the document where non-selected items may be hidden or dimmed (e.g., graphically grayed out of the document) in the document display. As a result, only selected items are shown and previewed in place in the preview mode. Instructions for items to be displayed in the preview display are received from the preview module 210, which is discussed in more detail below.

The document creation module 204 comprises an application that allows the user to create documents. The document creation module 204 may provide a blank document or a document template from which a user may create a customized document. The document creation module 204 may also provide creation tools on various displays and panels via the graphics interface module 202. It is noted that such creation tools (e.g., line tool, shape tools, color and shading tools, animation tools) are well known to one skilled in the art of document creation applications and therefore are not discussed in detail herein.

In various embodiments, the document creation module 204 may work with the data access module 206 to access data, either locally or via a network, for information. The accessed information may be imported or incorporated from the local database 112 and database(s) 114 into the document. For example, clipart or a media file may be obtained from one of the databases 112 and 114 and incorporated into the document.

The selection module 208 manages selections of items within the document being displayed in the document display. In some embodiments, the selection module 208 receives a selection of one or more items from a user via the communication module 108. The selection may occur based on the user clicking on an item, using a function key (e.g., shift key or control key) to click on more than one item, or using a selection box (e.g., mouse left-click and drag open a box to encompass the items of interest) to select one or more items in the document within the document display.

The preview module 210 manages a preview of the selected items. In example embodiments, the preview module 210 will display only the selected one or more items performing any interactive function associated with the selected one or more items within a preview display. Alternatively, the selected one or more items may be displayed in a static state (e.g., without performing any interactive functions). In some instances, the preview display may appear on the preview panel. In other instances, the preview display may be the document display (e.g., the preview is embedded within the document), whereby non-selected items are hidden or dimmed (e.g., graphically grayed out) from the document display during the preview. The preview module 210 sends instructions for rendering the appropriate selected items in the proper preview display to the graphics interface module 202.

The preview module 210 also provides a set of preview tools for use with the preview display. The set of preview tools may include various buttons to control the display of the selected items or a page/spread of the document. Other preview tools may include a preview play indicator which starts the interactive functions. Other preview tools may include, for example, a stop/pause button, a rewind button, a forward button, and a preview settings menu. Some of the preview tools may be inoperative depending on the interactive functions associated with the selected items. In these cases, the inoperative preview tools may be graphically shown grayed out. For example, if the preview tool is set to preview selections and no items are selected, then the preview play indicator may be grayed out. Other preview tools may let the user set preview options, for example, to preview items as a rasterized image or view the result in a browser directly.

The preview tool or setting may also allow the user to select whether to perform the interactive function when previewing the selected items. Thus, the user may preview the selected items as if the selected items are static. This may be useful to verify an appearance of the selected items on the document. Other settings may control other aspects of the preview appearance and frame rate controls a smoothness of resulting previews.

In some cases, the preview module 210 may provide a warning if an interactive function cannot be performed. For instance, the user device 102 may not be connected to the network 104 when a hyperlink is previewed. In another example, a media file may be missing (e.g., a media file associated with the video 304 is missing), which will cause the preview to fail. In yet another example, if the preview setting is set to preview the selection as a rasterized image, interactive functions may fail.

The hyperlink test module 212 tests a hyperlink within the document. When a hyperlink is selected for preview, the hyperlink test module 212 will attempt to access a webpage associated with the selected hyperlink. The webpage may then be provided in the preview display. Alternatively, the webpage may be provided on a new display window (e.g., pop-up window) distinct from the preview display.

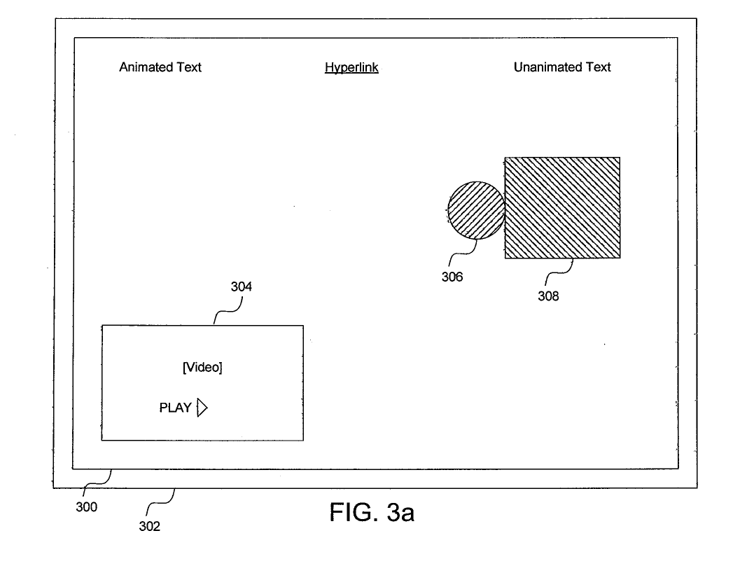

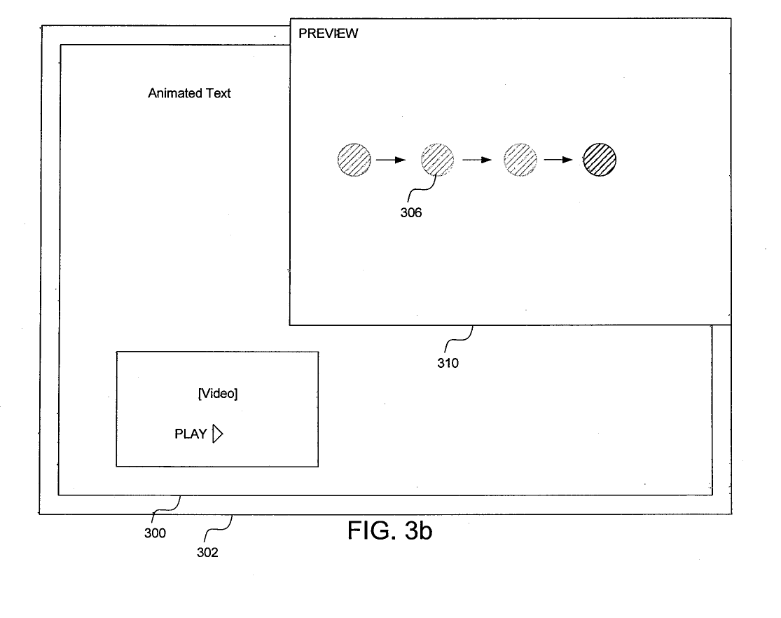

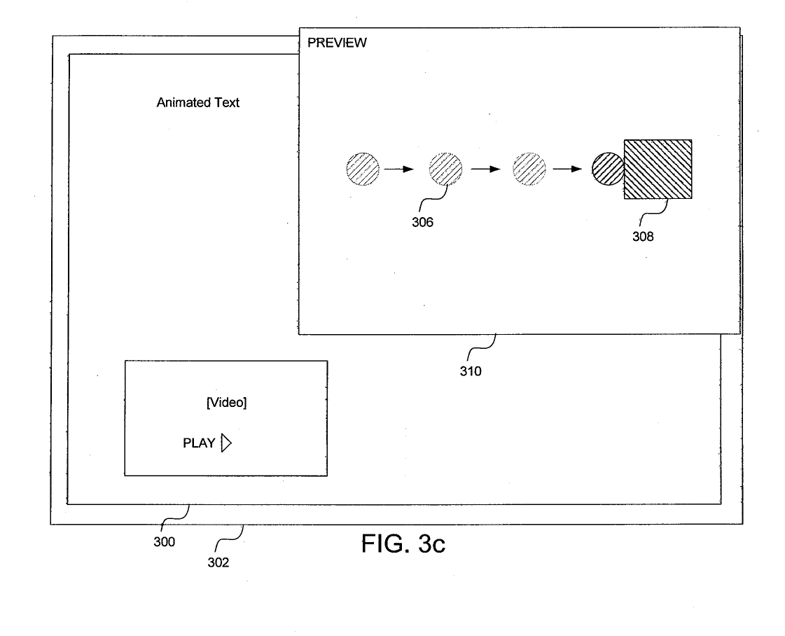

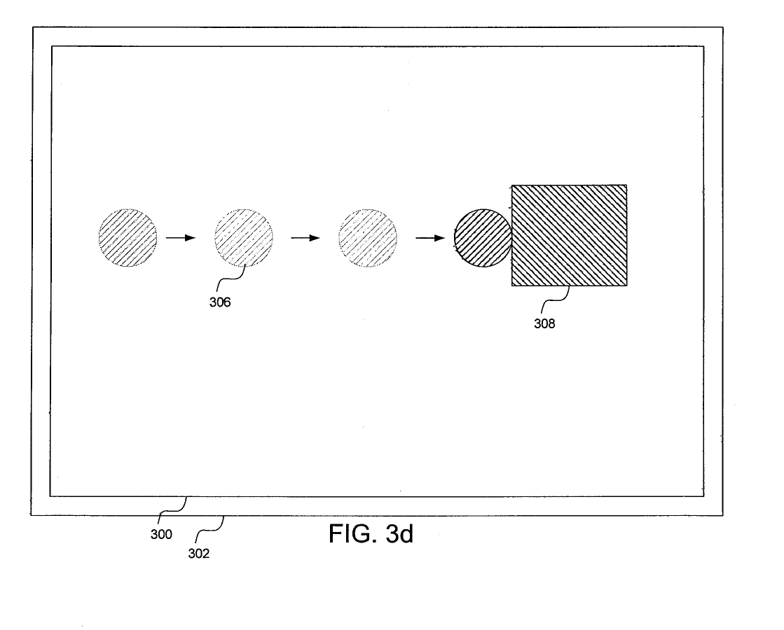

FIG. 3a illustrates an example document 300 displayed in a document display 302. For simplicity, creation tools normally provided by the document creation module 204 via the graphic interface module 202 are not shown on the document display 302. The example document 300 includes various items including animated (or dynamic) text, a hyperlink, and unanimated text at a top portion. The unanimated text is static text which does not move or change. The hyperlink is an active link to a webpage. The items on the example document 300 further include a video 304 and two graphics comprising an animated circle graphic 306 and an unanimated square graphic 308. The video 304 may be activated automatically (e.g., timed upon display of the page or spread the video is on) or may be manually activated (e.g., selecting a play icon or clicking on the video 304).

Any of the items may have an animated interactive function associated with it. The animated interactive function may be any one or more of, for example, fade in/out, fly right/left, fly up/down, flash, change color, or any other graphical transitions. Essentially, any visual change that can occur to the items may be used in animating the item.

In some embodiments, the interactive function is a trigger to perform an action, such as another interactive function. For instance, the item may be a button. When the button is selected, the interactive function of the button causes an action associated with the button to occur. For example, the button may be a “play” button, which when activated causes a video to be displayed.

It should be noted that any number and types of items may be provided on the document 300. For example, the document 300 may include only a plurality of animated text and a single graphic (without a hyperlink or unanimated text). Additionally, any type of graphic, whether dynamic/animated or static/unanimated, may be utilized. For example, the graphic may be a photograph, chart, drawing, or any other type of image of any size, shape, or color.

FIG. 3b illustrates the document 300 in the document display 302 with a preview panel 310 distinct from the document display 302. In this example, the preview panel 310 comprises the preview display illustrating the selected circle graphic 306. Because the circle graphic 306 has a “fly right” interactive function associated with it, the preview of the circle graphic 306 shows the circle graphic 306 moving to the right (as illustrated by the arrows). Thus, in the example preview of FIG. 3b, only one item (i.e., the graphic circle 306) is selected for preview in the preview display.

Referring now to FIG. 3c the preview panel 310 now illustrates a static (unanimated) item and a dynamic (animated) item. In this example, the user has selected the animated graphic circle 306 and the unanimated graphic square 308 for preview. Thus, the preview display within the preview panel 310 shows the graphic circle 306 moving towards the graphic square 308. The user may select any combination of animated and unanimated items when previewing items from the document 300.

FIG. 3d illustrates an example of an alternative preview display. Similar to the embodiment illustrated in FIG. 3c, the user has selected the animated graphic circle 306 and the unanimated graphic square 308 for preview. However, unlike the embodiment of FIG. 3c, the preview display is within the document display 302. Any items not selected for preview (e.g., the animated text, hyperlink, unanimated text, and video 304) are removed from the document display 302. Only the selected graphic circle 306 (shown moving across the document by the arrows) and the selected graphic square 308 are presented in the preview display.

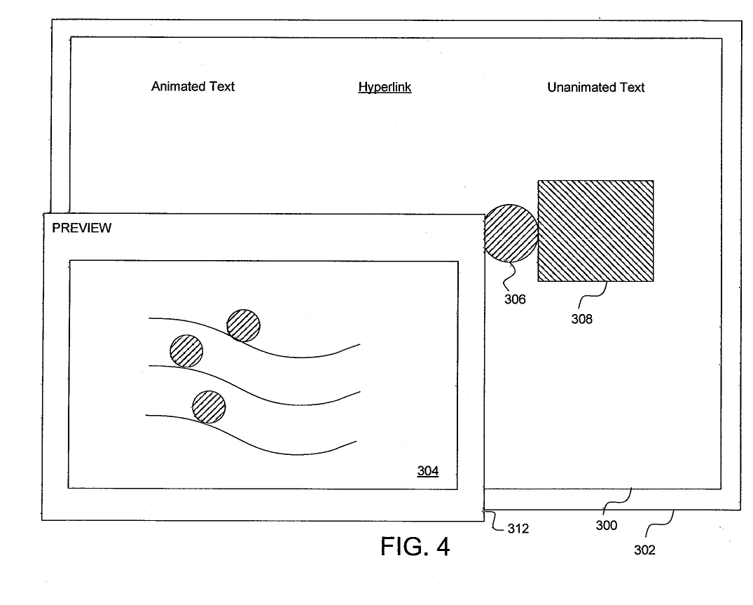

FIG. 4 illustrates the display of the example document 300 with a preview panel 312 displaying the video 304. In this example, the user has selected to preview the video 304 by, for example, selecting the video 304 and selecting a preview mode indicator. In response to the selection of the preview mode indicator, a preview mode is triggered whereby the preview panel 312 is provided within which the video 304 may be shown.

In an alternative embodiment, the preview may be provided within the document display 302 without providing the preview panel 312. In this alternative embodiment, the unselected items (e.g., the animated text, hyperlink, unanimated text, graphics items) may be removed (e.g., hidden) or just dimmed (e.g., graphically grayed out) from the document display so that only those selected items (e.g., the video 304) are shown or previewed in place. In one instance, the video 304 may be expanded to encompass the entire size of the document display 302. Alternatively, the video 304 may be previewed within a portion of the document display 302 that is the same size as the video that is shown within the document 300.

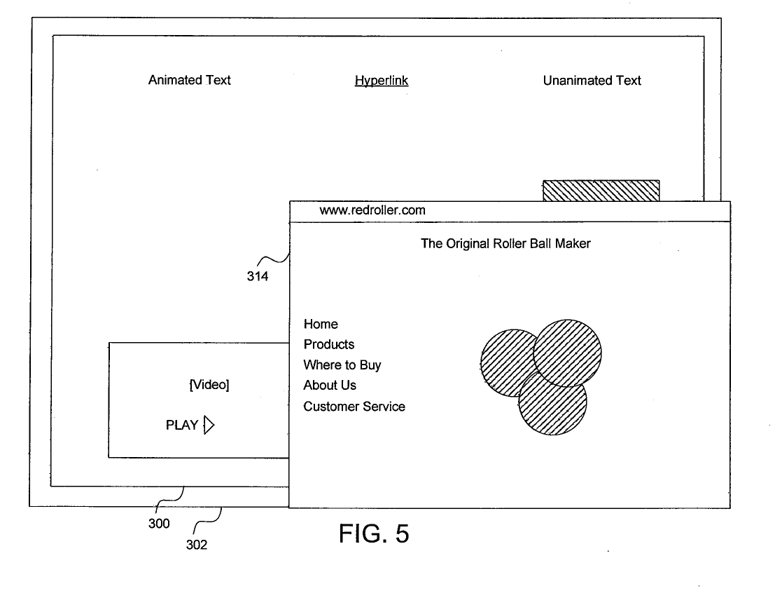

FIG. 5 illustrates the display of the document 300 along with a hyperlink test display. In this example, the user selected the hyperlink for preview. As a result, a preview panel 314 in the form of a new window opens up displaying a webpage associated with the selected hyperlink. In an alternative embodiment, the document 300 may be replaced by the webpage within the document display 302.

Thus, FIG. 3b-FIG. 5 illustrate and describe various examples of preview displays as well as different combinations of items selected for preview in various preview displays. It is noted that any combination of items may be selected for preview and should not be limited to those shown and described herein. Similarly, any form of a preview display may be utilized by embodiments of the present invention and the various display locations and displays may comprise any size or be resizable.

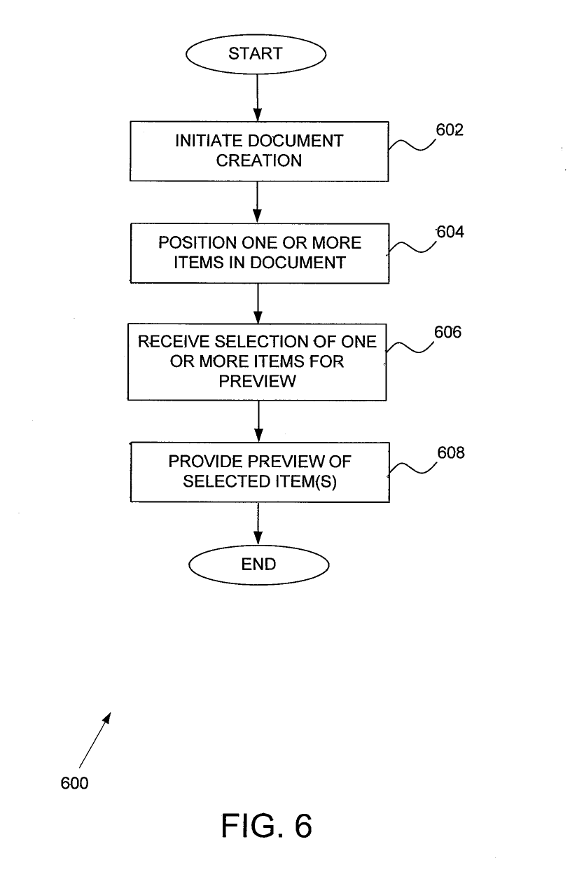

FIG. 6 is a flowchart of a method for creating a document and previewing items in the document. In operation 602, document creation is initiated. A blank document or a document based on a template may be provided to the user by the graphic interface module 202. The document is presented within a document display. The document display may include a set of creation tools which the user may utilize to customize the document.

In operation 604, one or more items are positioned within the document. Each item may be created by the user (e.g., using a drawing tool, the user draws out an item) or be incorporated from another source (e.g., from database 112 or 114). In some cases, the item may have an interactive function applied to it or otherwise associated with it. The interactive function may include animation, be a hyperlink, provide a video, or be any other dynamic activity.

A selection of one or more items for preview is received in operation 606. For example, the user may desire to test an interactive function applied to one or more items without having to preview all interactive functions applied to all items within the document. Thus, the user will select the one or more items for preview. Selection may be indicated by clicking on the one or more items or selecting a group of items using a single action (e.g., mouse left-click and drag open a box to encompass the items of interest).

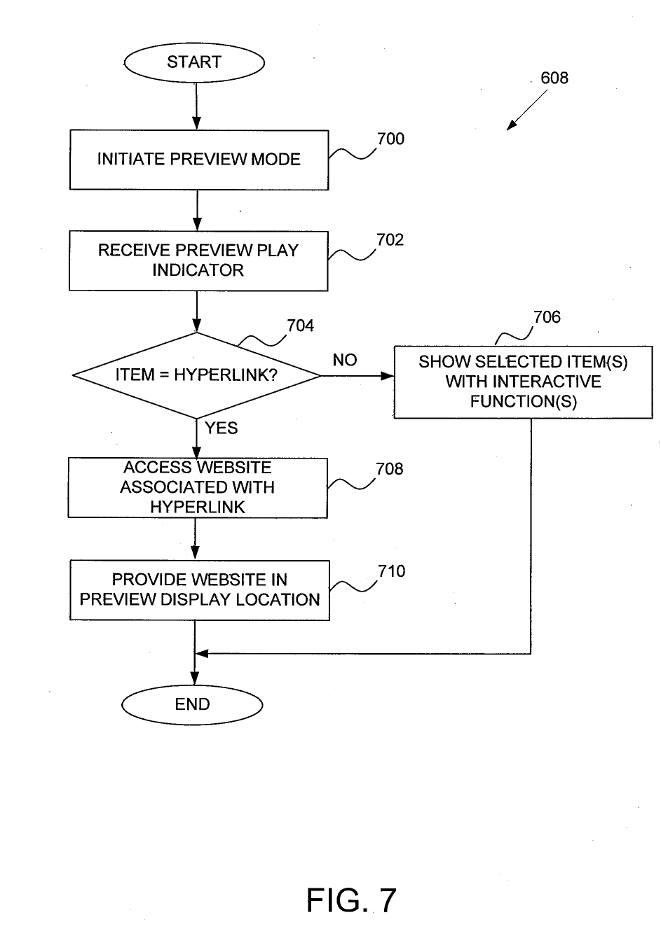

Based on the selection in operation 606, a preview of the selected items is provided in operation 608. The preview is provided in a preview display. The preview display may be presented in a preview panel distinct from the document display or the preview display may be the document display. Operation 608 is described in more detail in connection with FIG. 7.

FIG. 7 is a flowchart of a method for providing the preview of selected items (e.g., operation 608). In operation 700, the preview mode is initiated. In some embodiments, the user may select one or more items and select a preview mode indicator. The selection of the preview mode indicator may cause a preview display to be rendered. The preview display may initially show the selected items in a static (e.g., unanimated) format.

In operation 702, a preview play indicator is received. In embodiments where the selected items are statically displayed in the preview display upon initiating the preview mode, the user selects a preview play indicator to activate any interactive functions. For example and referring back to FIG. 3d, upon receiving the preview mode selection in operation 700, the preview display may show only the graphic circle 306 positioned against the graphic square 308. When the user selects a preview play indicator, the graphic circle 306 will be positioned to the right and move towards the final position next to the graphic square 308.

It is noted that operation 702 is optional. In some embodiments, selecting the items and triggering the preview mode in operation 700 will automatically cause the preview mode to execute the interactive functions.

In operation 704, a determination is made as to whether one of the selected items is a hyperlink. If there are no hyperlinks selected, then the selected one or more items are shown performing the associated interactive function(s), if any, in operation 706. In example embodiments, the preview module 210 will provide instructions to the graphic interface module 202 to display the selected items and apply the interactive function(s).

However, if one of the selected items is a hyperlink, then in operation 708, a webpage associated with the hyperlink is accessed. In various embodiments, the hyperlink test module 212 will test the hyperlink by accessing the webpage. The accessed webpage is then provided in the preview display in operation 710.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein, as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

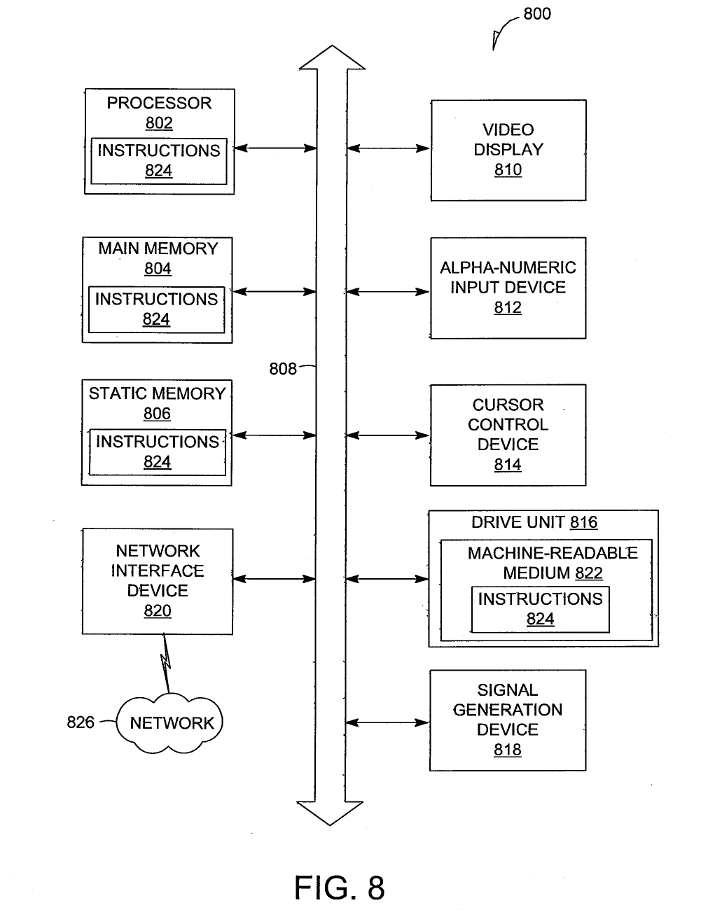

With reference to FIG. 8, an exemplary embodiment extends to a machine in the example form of a computer system 800 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 may include a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). In exemplary embodiments, the computer system 800 also includes one or more of an alpha-numeric input device 812 (e.g., a keyboard), a user interface (UI) navigation device or cursor control device 814 (e.g., a mouse), a disk drive unit 816, a signal generation device 818 (e.g., a speaker), and a network interface device 820.

### Machine-Readable Storage Medium

The disk drive unit 816 includes a machine-readable storage medium 822 on which is stored one or more sets of instructions 824 and data structures (e.g., software instructions) embodying or used by any one or more of the methodologies or functions described herein. The instructions 824 may also reside, completely or at least partially, within the main memory 804 or within the processor 802 during execution thereof by the computer system 800, the main memory 804 and the processor 802 also constituting machine-readable media.

While the machine-readable storage medium 822 is shown in an exemplary embodiment to be a single medium, the term “machine-readable storage medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 824 may further be transmitted or received over a communications network 826 using a transmission medium via the network interface device 820 and utilizing any one of a number of well-known transfer protocols (e.g., HyperText Transfer Protocol (HTTP)). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A method comprising:
receiving a selection of a selected item having an interactive function from within a document that is being created, the document including the selected item and a non-selected. item;
receiving an indication preview a portion of the document that is being created, the portion including the selected item and excluding the non-selected item;
displaying, using one or more processors, the selected item having the interactive function within a preview display, the preview display excluding the non-selected item of the document that is being created; and
based on the interactive function being an animation applied to the selected item of the document that is being created, applying the animation to the selected item to cause an image of the selected item to be animated within the preview display.

2. (canceled)

3. The method of claim 1, wherein the selection comprises a second selected item having a second interactive function and based on the second selected item being a video display or sound, performing the second interactive function within the preview display.

4. The method of claim 1, wherein the selection comprises a second selected item having a second interactive function and based on the second selected item being a hyperlink to a webpage, performing the interactive function within the preview display.

5. The method of claim 1, wherein the selection comprises a second selected item having a second interactive function and based on the second selected item being a trigger for another item, performing the second interactive function within the preview display.

6. The method of claim 1, wherein the displaying comprises providing a preview panel distinct from a document display displaying the document, the preview panel comprising the preview display.

7. The method of claim 1, wherein the excluding of the non-selected item comprises removing, hiding, or dimming the non-selected item from a document display displaying the document and previewing the selected item in-place within the document.

8. The method of claim 4, further comprising determining that the second selected item is a hyperlink, accessing a webpage associated with the hyperlink, and displaying the webpage based on the determination that the second selected item is a hyperlink.

9. The method of claim 1, wherein the displaying is automatically triggered based on the selection of the selected item and initiation of a preview mode.

10. The method of claim 1, further comprising receiving a preview play indicator, the displaying being triggered upon receipt of the preview play indicator.

11. A system comprising:
a processor of a machine;
a selection module to receive a selection of a selected item having an interactive function from within a document that is being created, the document including the selected item and a non-selected item; and
a preview module to display, using the processor, the selected item having the interactive function within a preview display, and based on the interactive function being an animation applied to the selected item of the document that is being created, to apply the animation to the selected item to cause an image of the selected item to be animated within the preview display, the preview display excluding the non-selected item of the document that is being created.

12. The system of claim 11, further comprising a hyperlink test module to access a webpage associated with a hyperlink and provide the webpage in the preview display based on the interactive function being associated with a hyperlink.

13. The system of claim 11, further comprising a graphics interface module to provide a preview panel distinct from a document display displaying the document, the preview panel comprising the preview display.

14. The system of claim 11, wherein the preview module removes, hides, or dims the non-selected item from a document display displaying the document and uses the document display as the preview display.

15. A machine-readable storage medium in communication with at least one processor, the machine-readable storage medium storing instructions which, when executed by the at least one processor performs operations comprising:
receiving a selection of a selected item having an interactive function from within a document that is being created, the document including the selected item and a non-selected item;
receiving an indication to preview a portion of the document that is being created, the portion including the selected item and excluding the non-selected item:
displaying the selected item having the interactive function within a preview display, the preview display excluding the non-selected item of the document that is being created; and
based on the interactive function being an animation applied to the selected item of the document that is being created, applying the animation to the selected item to cause an image of the selected item to be animated within the preview display.

16. The machine-readable storage medium of claim 15, wherein the displaying comprises providing a preview panel distinct from a document display displaying the document, the preview panel comprising the preview display.

17. The machine-readable storage medium of claim 15, wherein the excluding of the non-selected item comprises removing the non-selected item from a document display displaying the document and using the document display as the preview display.

18. The machine-readable storage medium of claim 15, wherein the operations further comprise determining whether the selected item is a hyperlink.

19. The machine-readable storage medium of claim 18, wherein the operations further comprise accessing a webpage associated with the hyperlink and displaying the webpage based on the determination that the selected item is a hyperlink.

20. The machine-readable storage medium of claim 15, wherein the displaying is automatically triggered based on the selection of the selected item and initiation of a preview mode.

21. The method of claim 1, wherein the selection includes a selection of a non-animated item, the non-animated item being displayed with the selected item having the interactive function that is an animation in the preview display.

22. The method of claim 1, wherein the animation that is the interactive function applied to the selected item is selected from the group consisting of fade in, fade out, fly right, fly left, fly up, fly down, flash, and change color.
